(19) United States
(12) Patent Application Publication
(10) Pub. No.: US 2003/0055678 A1
(43) Pub. Date: Mar. 20, 2003

(54) Use right management system and storage medium

(75) Inventors: Yukio Nakayama, Kawasaki (JP); Chiaki Fujiya, Kawasaki (JP); Kaoru Sakamoto, Kawasaki (JP); Junko Mashiko, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/286,862

(22) Filed: Nov. 4, 2002

Related U.S. Application Data
(63) Continuation of application No. PCT/JP01/04605, filed on May 31, 2001.

(30) Foreign Application Priority Data
Jun. 1, 2000 (JP) 2000-165071

(51) Int. Cl. G06F 17/60

(52) U.S. Cl. 705/1

(57) ABSTRACT

A right-of-use database stores one or more rights of use of merchandise. Also provided are a unit permitting merchandise to be used when it is determined by referring to the right-of-use database that a right of use is obtained, and prohibiting the merchandise from use when it is determined that there is no right of use or the right of use has expired, and a unit performing a job using the merchandise when using the merchandise is permitted, and decreasing an amount of use from the right of use stored in the right-of-use database.

### CROSS REFERENCE TO RELATED APPLICATION

This application is a continuation of international PCT application No. PCT/JP01/04605 filed on May 31, 2001.

### BACKGROUND OF THE INVENTION

1. Field of the Invention

The present invention relates to a use right management system for managing the use of merchandise, and a storage medium.

2. Description of the Related Art

Conventionally, when an office uses a package of expensive software for business use in the office, and then provides a service for a user, the office normally pays the rent for the hardware of a computer system, and also pays the rent for the package by installments depending on the period (for example, five years) of the lease on the hardware.

As a result, there has been the problem that services cannot be provided for a number of users using the package by increasing the number of computer systems, for example, personal computers, for the necessary number of months for the package at any time.

### SUMMARY OF THE INVENTION

To solve the above mentioned problem, the present invention aims at realizing a system capable of purchasing one or more rights of use of merchandise, storing them in a right-of-use database (hereinafter referred to as a right-of-use DB), using the merchandise within the scope of the rights of use, using the merchandise after importing the rights of use to other computer systems, dividing the rights of use of the merchandise, etc. thereby flexibly managing the discount, etc. of the merchandise.

The use right management system according to the present invention includes in a use right management system for managing the use of merchandise, a right-of-use database storing one or more rights of use of merchandise; a unit for permitting the use of merchandise when it is determined by referring to the right-of-use database that a right of use of the merchandise is permitted, prohibiting the use of the merchandise when it is determined that the right of use is not permitted or that the right of use has been expired; and a unit for performing a job using the merchandise when the use is permitted and reducing the amount of use from the right of use stored in the right-of-use database.

According to the present invention, one or more rights of use of merchandise are purchased and stored in a right-of-use database, the merchandise is used within the scope of the rights of use, and the merchandise is used after importing the rights of use to other computer systems, etc. Therefore, the present invention can realize a system capable of flexibly managing the rights of use by performing a job using a plurality of rights of use of merchandise, dividing and importing the rights of use into other computer systems, discounting/removing the discount of the rights of use when the rights of use are imported/purchased, etc.

### BRIEF DESCRIPTION OF THE DRAWINGS

FIG. 1 shows the configuration of the system according to the present invention.

FIG. 2 is a flowchart (generating a right-of-use file) of the operations according to the present invention;

FIG. 3 shows an example of a right-of-use file according to the present invention;

FIG. 4 is a flowchart of the operations (purchasing/contracting/downloading/setting/operating) according to the present invention;

FIG. 5 is a flowchart of the operations (dividing a right of use) according to the present invention;

FIG. 6 illustrates the method for registering the right of use according to the present invention;

FIG. 7 is a flowchart of the operation (exporting) according to the present invention;

FIG. 8 is a flowchart of the operation (importing) according to the present invention;

FIG. 9 is a flowchart of the operation (checking (1)) according to the present invention;

FIG. 10 is a flowchart of the operation (checking (2)) according to the present invention;

FIG. 11 is a flowchart of the operation (dividing) according to the present invention;

FIG. 12 shows an example of a practical configuration of a right-of-use file;

FIG. 13 shows an example of a practical configuration of a right-of-use DB

FIG. 14 shows an example of a practical configuration of a previous activation date table;

FIG. 15 shows an example of a practical configuration of an export/import file; and

FIG. 16 shows an example of a practical configuration of an export/input management DB.

### DESCRIPTION OF THE PREFERRED EMBODIMENTS

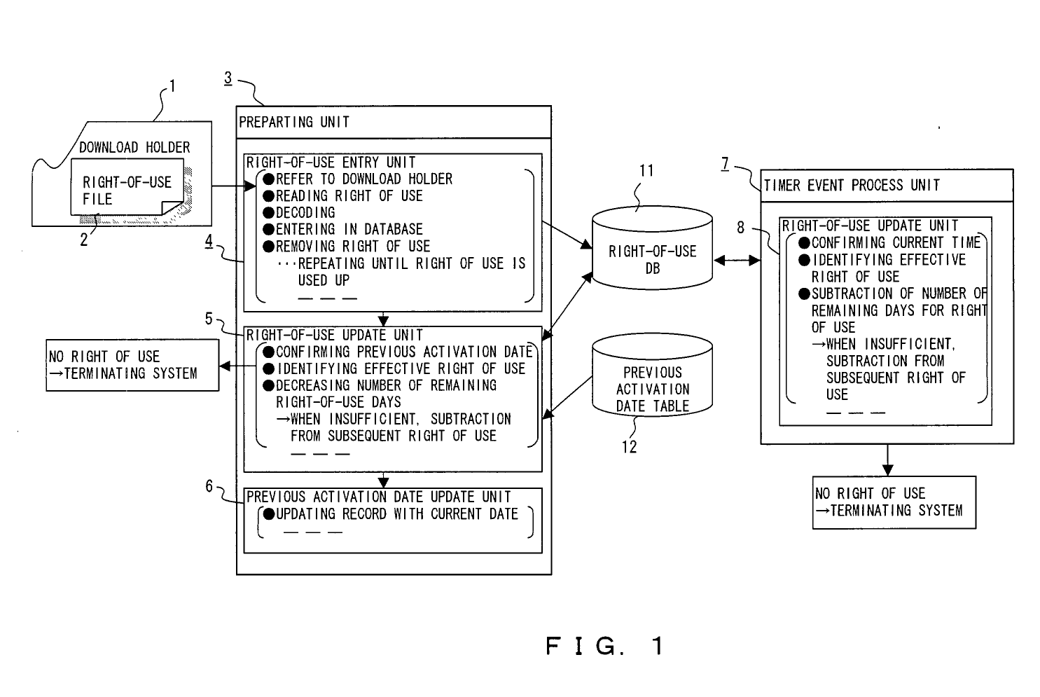

The principle of the present invention is described below by referring to FIG. 1.

In FIG. 1, a right-of-use entry unit 4 registers a right of use in a right-of-use DB 11.

Right-of-use update units 5 and 8 update a right of use depending on the use of merchandise

Described below are the operations of the units.

When the right-of-use entry unit 4 stores one or more rights of use of merchandise in the right-of-use DB 11, and the right-of-use update units 5 and 8 determines by referring to the right-of-use DB 11 if the use of the merchandise is permitted according to the right of use. When they determine that there is no right of use or the duration of service has expired, they prohibit the use of the merchandise. Thus, when the use of the merchandise is permitted, the merchandise can be used to perform a job, and the amount of use is decreased from the right of use stored in the right-of-use DB 11.

At this time, the right of use stored in the right-of-use DB 11 is retrieved and exported at a request to divide the right, and the right is removed from the right-of-use DB 11.

Furthermore, when a right of use is imported or purchased, and when there is an import or purchase it is stored in the right-of-use DB 11.

When a right of use is imported or purchased, and when the right of use is assigned to a first or subsequent importing or purchasing unit, the right of use can be stored as is, as a discounted right, or as a return-from-discount right in the right-of-use DB 11.

In addition, after a predetermined period has passed from a predetermined date such as an issue date, check date, start of operation date, etc. of a right of use, an inquiry is issued to an office from which the right of use has been purchased or to a predetermined office to ask whether or not the right of use is allowed. If YES, the right of use is allowed. If NO, the right of use is set as not allowed.

If it is determined that the right of use is unused for a certain period by comparing the previous date of use and the current date of use, then the period of non-use is not subtracted from the right of use.

A system capable of flexibly managing the rights of use is realized by enabling to purchase one or more rights of use of merchandise and store them in the right-of-use DB 11 to use the merchandise within the range of the rights of use or to import them into another computer system to use the merchandise by importing the divided rights of use into other computer systems or to make discount or removal of discount of the right of use, etc,.

The embodiments and operations of the present invention are sequentially described below by referring to FIGS. 1 through 11.

FIG. 1 shows the configuration of the system according to the present invention.

In FIG. 1, a download holder 1 is provided in a center (server) connected to a network such as Internet. In this example, a right-of-use file 2 is stored and referred to on a website.

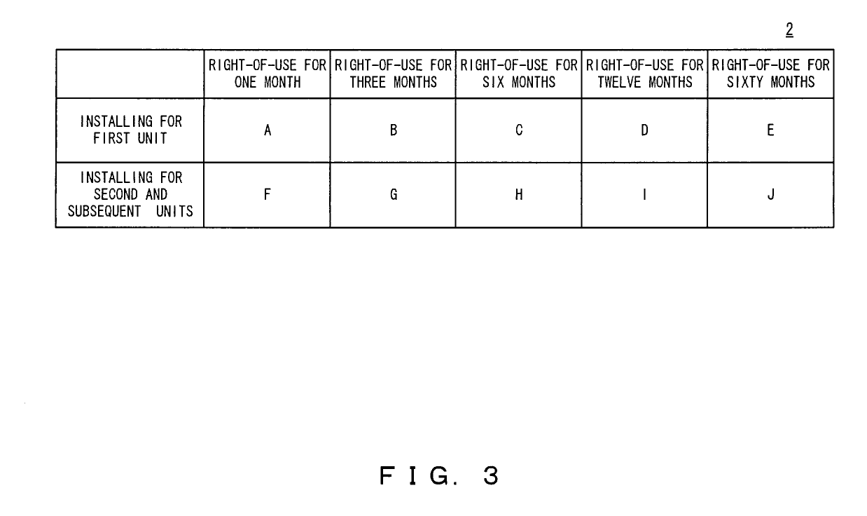

The right-of-use file 2 stores a right of use of merchandise registered therein, and has each piece of merchandise (including software and a service provided for a user on the site in this specification) registered in association with a purchasable right of use (right of use determined by the duration of service, the number of an available personal computer, etc.) (refer to FIG. 3).

A preparing unit 3 refers to the right-of-use file 2 in the download holder 1 in the server through a network, downloads a purchased right of use and registers it in the right-of-use DB 11, decreases the right of use each time the merchandise is used. In this example, the preparing unit 3 comprises the right-of-use entry unit 4, the right-of-use update unit 5, and a previous activation date update unit 6.

The right-of-use entry unit 4 refers to the download holder 1 in the download holder of the server connected to the network, downloads the purchased right of use, registers a decoded right of use in the right-of-use DB 11, etc.

The right-of-use update unit 5 confirms the previous activation date of merchandise, checks whether or not the current date and time is in the range of the term of validity, decreases the number of remaining days for the right of use when the current date and time is within the range of the term of validity, starts the operation after decreasing the number from the next right of use if there is no remaining days, and furthermore, the system terminates as no right of use when there is no right of use.

The previous activation date update unit 6 updates a previous activation date table 12 on the current activation date in preparation for the next activation.

A timer event process unit 7 starts a process using a timer. In this example, it activates the right-of-use update unit 8 when the use of merchandise carries into a new day.

The right-of-use update unit 8 confirms the current time, and determines whether or not a valid right of use is exercised when using merchandise is to continue into a new day, continues the operation after decreasing the number of remaining days of the right of use. If the number is too small, it starts the operation after decreasing the next right of use. If the number is further smaller, it is determined that there is no right of use, thereby terminating the system.

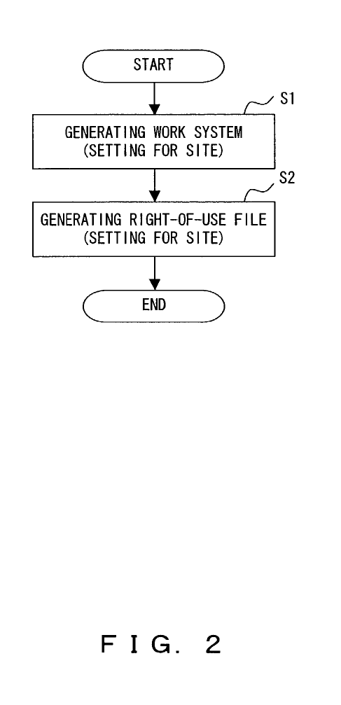

FIG. 2 is a flowchart for explanation of the operations (generating a right-of-use file) according to the present invention.

In FIG. 2, a work system is generated in S1. That is, a work system (merchandise, package) is generated and set on the site (server) by the server side.

A right-of-use file is generated in S2. That is, a right-of-use file as shown in FIG. 3 is generated when merchandise is used by registering necessary right of use with encryption on the site (server).

As described above, the right-of-use file (an encrypted file in which necessary keys, the term of validity, etc. are set to use (merchandise)) which is required to get/use a work system (merchandise) and encrypted, can be set on the access site (server) connected to a network, and the user is ready to access the server to purchase merchandise as necessary.

FIG. 3 shows an example of a right-of-use file according to the present invention. The right-of-use file 2 is an example set in S2 shown in FIG. 2 on the server site. In this example, the merchandise is sorted and registered as a right-of-use file depending on the term of validity and the number of the personal computer (terminal) used. In this example, the following terms are set to sort the rights of use for the installation of the first unit and the installation of the second and subsequent units at a discount depending on the total number of installed units. In this example, ten types of rights of use from A to J are set as shown in FIG. 3.

right of use for 1 month

right of use for 3 months

right of use for 6 months

right of use for 12 months

right of use for 60 months

As described above, the term of validity of a right of use, and the right of use with the discount taken into account separately for the first and the subsequent units are encrypted and set in the right-of-use file 2. At this time, although not shown in the attached drawings, the information such as available merchandise and the period (normally 2 months) for check of forgery and suspended payment of a purchased right of use known by inquiring them of the site (server), etc. is set.

In the example of the above mentioned right-of-use file, assume that the first unit is a server, and the second and subsequent units are clients who transmit and receive using the server and merchandise. In this case, if 2-unit charge is required for the server to use the merchandise, then a discount of allowing 1-unit charge can be realized on condition that the client uses the merchandise. In this case, when the server and the client purchase the same amount of rights of use, the number of days on which the client can use the merchandise can be set double the number of days on which the server can use the merchandise.

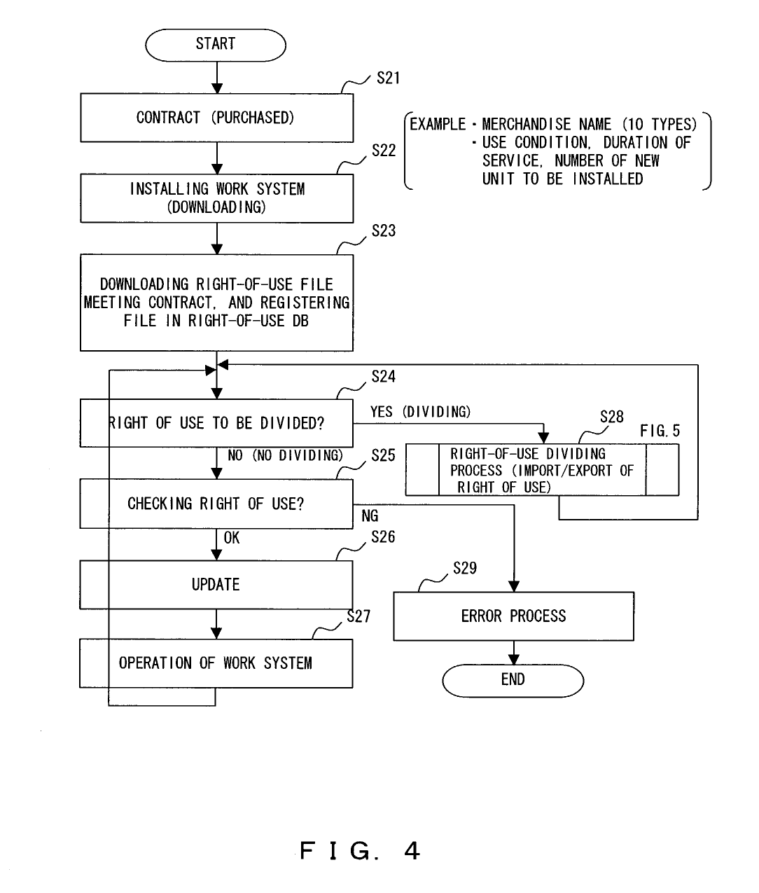

FIG. 4 shows the flowchart of the operations (purchase of merchandise/contract/download/setting/operation) according to the present invention.

In FIG. 4, a contract is made in S21. The contract is made to purchase a right of use of merchandise by connection to the server. The content of contract is exemplified on the right of the figure.

name of merchandise: one or more name of merchandise among ten types of merchandise A-J shown in FIG. 3, for example

condition of use: duration of service (for example, 3 months)

how many computers are there after introducing the merchandise to a new computer (for example, for a first unit)

A work system is installed (downloaded) in S22. The work system (merchandise, package) in the contract (purchase contract) in S21 is downloaded, installed into a personal computer, and is ready for use.

In S23, merchandise corresponding to the contract is downloaded by referring to the right-of-use file, and registered in the right-of-use DB.

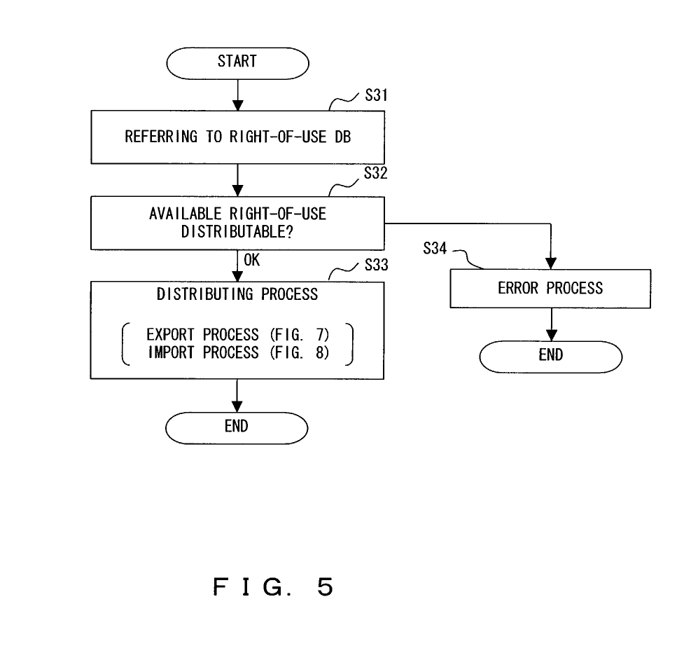

It is determined in S24 whether or not a right of use is to be divided. For example, it is determined whether or not the right of use is to be divided to use the work system using the divided right of use through another personal computer in an office to which one of the rights of use set in the right-of-use DB 11 for the first personal computer in the office is exported. If YES, it is determined that the right of use is to be divided, and the process of dividing the right of use (exporting/importing the right of use) is performed in S28 described later as shown in FIG. 5. Then, control is returned to S24. If NO, it is determined that the right of use is not to be divided, and control is passed to S25.

The right of use is checked in S25. That is, it is checked whether or not the right of use is within the term of validity, whether or not the right of use is effective for the target merchandise. If YES, control is passed to S26. If NO, it is determined that the right of use is not available, and an error process is performed, thereby terminating the system.

An updating process is performed in S26. That is, the number of days remaining for the right of use in the right-of-use DB 11 is decreased and updated.

The work system is operated in S27. Then, control is returned to S24, and the processes are repeated.

As described above, merchandise is downloaded and installed through connection to the site (server) connected to a network using a personal computer, the right of use of the merchandise is purchased and registered in the right-of-use DB 11, thereby enabling the work system (merchandise) to be used with the right of use and within the range of the right of use. At this time, the right of use registered in the right-of-use DB 11 is divided as necessary, and exported/imported to other personal computers, thereby enabling the work system to be operated (used) within the range of the right of use based on the right of use of the other personal computers.

FIG. 5 is a flowchart of the operations (right-of-use dividing process) according to the present invention. It illustrates the details (of exporting and importing a right of use) of the process of dividing a right of use in S28 shown in FIG. 4.

In FIG. 5, a right-of-use DB is referred to in S31.

It is determined in S32 whether or not the owned right of use can be divided. For example, it is determined whether or not two or more rights of use in the right-of-use file 2 shown in FIG. 3 have been registered in the right-of-use DB 11. If YES, then control is passed to S33. If NO, then an error process (for example, the process of displaying the message that the right of use cannot be divided, and terminating the process) is performed in S34.

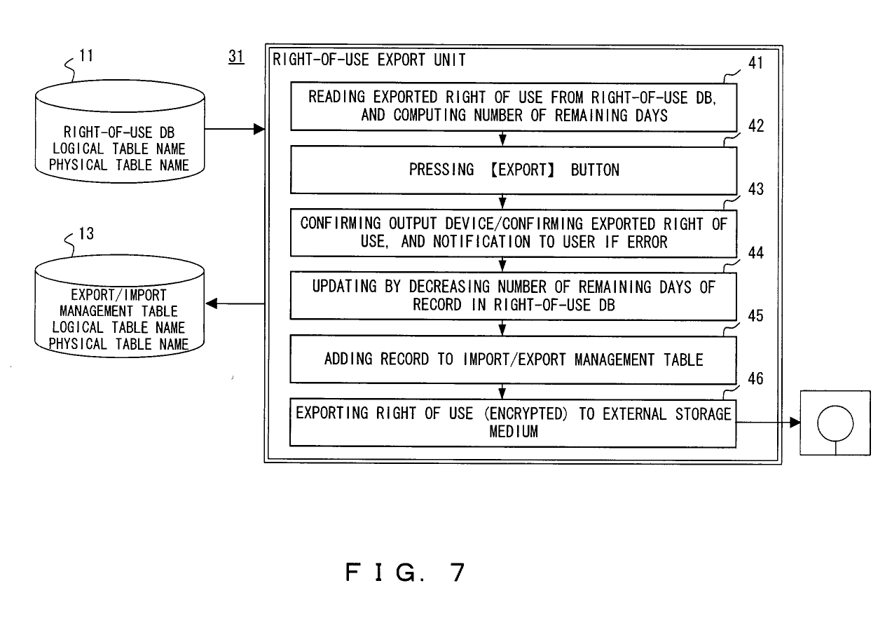

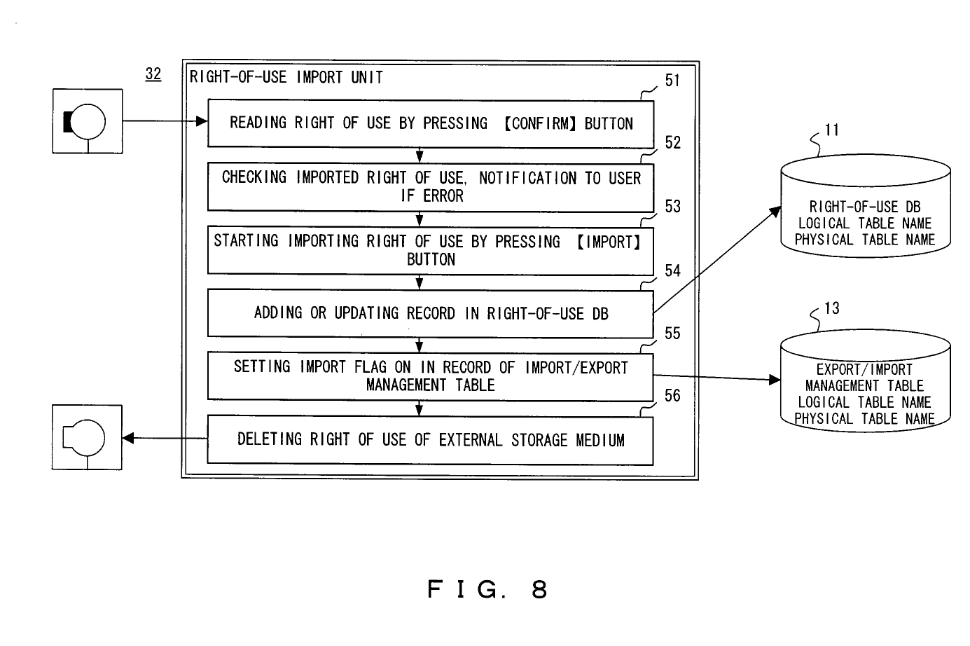

In S33, an exporting process (FIG. 7) and an importing process (FIG. 8) are performed as a dividing process. In the dividing process, the right of use is exported and deleted as shown in FIG. 7 using an export source personal computer as described later, and the right of use is imported as shown in FIG. 8 using an export destination personal computer.

Thus, when a right of use registered in the right-of-use DB 11 in a personal computer can be divided, the right of use is exported and deleted, registered in the right-of-use DB 11 by the export destination personal computer, and then used, thereby performing the process of dividing (exporting and importing) the right of use. Thus, when it is necessary for another personal computer to perform a work process in an office, the right of use is divided from the right-of-use DB 11 of a personal computer, exported to another personal computer, and the work process can be performed.

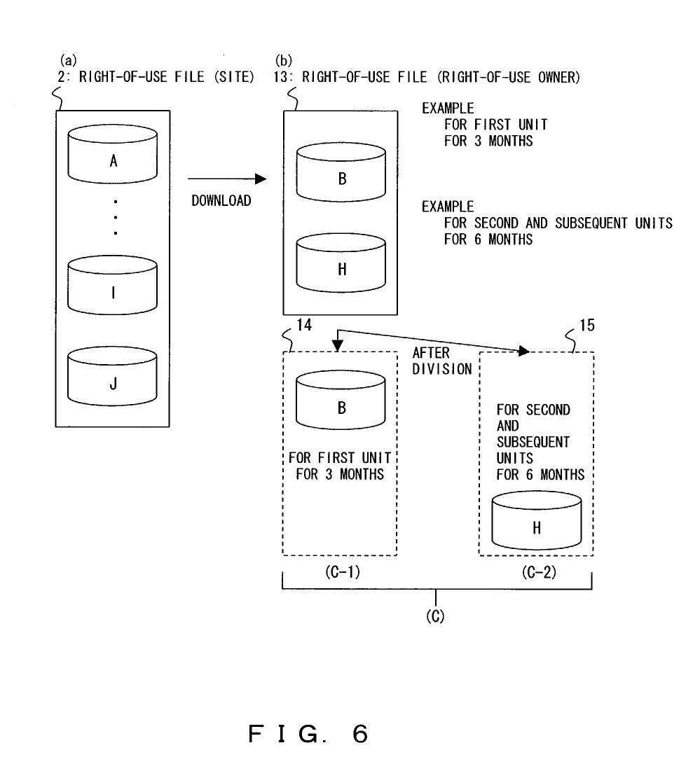

FIG. 6 illustrates the method of registering a right of use.

(a) in FIG. 6 shows an example of a right-of-use file (site). In this example, it is assumed that the ten types of rights of use from A to J in the right-of-use file 2 shown in FIG. 3 have been registered in the right-of-use file 2.

(b) in FIG. 6 shows an example of a right-of-use file (right-of-use owner). In this example, two rights of use, that is, B (for the first unit for two months) and H (for the second unit for 6 months), are purchased, downloaded, and registered in the right-of-use DB 11 in the personal computer.

(c) in FIG. 6 shows a right-of-use file (right-of-use owner).

(c-1) in FIG. 6 shows a right-of-use file (right-of-use owner) of a division source (export source).

(c-2) in FIG. 6 shows a right-of-use file (right-of-use owner) of a division destination (export destination). The right-of-use file of the personal computer shown by (b) in FIG. 6 contains two rights of use, that is, B and H. The division source (export source) has only the right of use of B shown by (c-1) in FIG. 6, and the division destination (export destination) has the right of use of H shown by (c-2) in FIG. 6. In the personal computer of (c-2) in FIG. 6, a work process can be performed using the right of use of H.

As described above, when a divisible right of use is stored in the right-of-use DB 11 of a personal computer, it can be divided and registered in the right-of-use DB 11 of another personal computer, and a work process can be performed using the right of use in the other personal computer.

FIG. 7 is a flowchart of the operations (exporting) according to the present invention. It is a detailed flowchart of the export process in S33 shown in FIG. 5.

In FIG. 7, a right-of-use export unit 31 exports a right of use in the right-of-use DB 11 to an external medium, deletes the exported right of use from the right-of-use DB 11, etc.

An export/import management table 13 manages the export and import of a right of use.

Described below is the operation of the right-of-use export unit 31.

In FIG. 7, a right of use is read from the right-of-use DB, and computes the number of remaining days in S41. In this process, the exported right of use is read, and, for example, the number of months of the exported right of use is subtracted from the total number of months, thereby obtaining the number of remaining months.

An export button is pressed in S42. In this process, the user checks the exported right of use, the number of months, the number of remaining months, etc. displayed on the screen, and issues an instruction to export a right of use.

In S43, an output device and an exported right of use are confirmed, and a notification is issued to the user if an error has occurred.

In S44, the number of remaining days of the record in right-of-use DB is decreased and updated. In this process, for example, the number of months of an exported right of use is subtracted from the number of remaining months in the right-of-use DB, and updated.

In S45, a record is added to the export/import management table 13.

In S46, a right of use (encrypted) is exported to an external storage medium. Thus, the right of use is encrypted and stored in the external medium.

As described above, the right of use stored in the right-of-use DB 11 of a personal computer can be encrypted and stored in the external storage medium, the number of months of the right of use exported from the right-of-use DB 11 is decreased, thereby dividing and exporting a right of use.

FIG. 8 is a flowchart of the operations (importing) according to the present invention. It is a detailed flowchart of an import process in S33 shown in FIG. 5.

In FIG. 8, a right-of-use import unit 32 reads a right of use from an external storage medium, and stores it in the right-of-use DB 11.

The export/import management table 13 manages the export and import of a right of use.

Described below is the operation of the right-of-use import unit 32.

In FIG. 8, a right of use is read by pressing a confirmation button in S51. In this process, when the user presses the confirmation button, an encrypted right of use is read from the external storage medium.

In S52, the imported right of use is checked, and the user is notified if an error has occurred.

In S53, the process of importing the right of use is started by pressing the import button.

In S54, a record is added to the right-of-use DB or updated. In this process, the import of a right of use is started in S53, and the right of use is decoded and added to the right-of-use DB 11 or updated. Thus, the number of remaining dates of the right-of-use DB 11 is added, or updated after the addition.

In S55, a record import flag of the export/import management table 13 is set ON.

In S56, a right of use of an external storage medium is deleted.

As described above, an encrypted right of use is read from the external storage medium by another personal computer, and is decoded and added to the right-of-use DB 11 or updated.

Then, using the imported right of use, the work system can be used in that range.

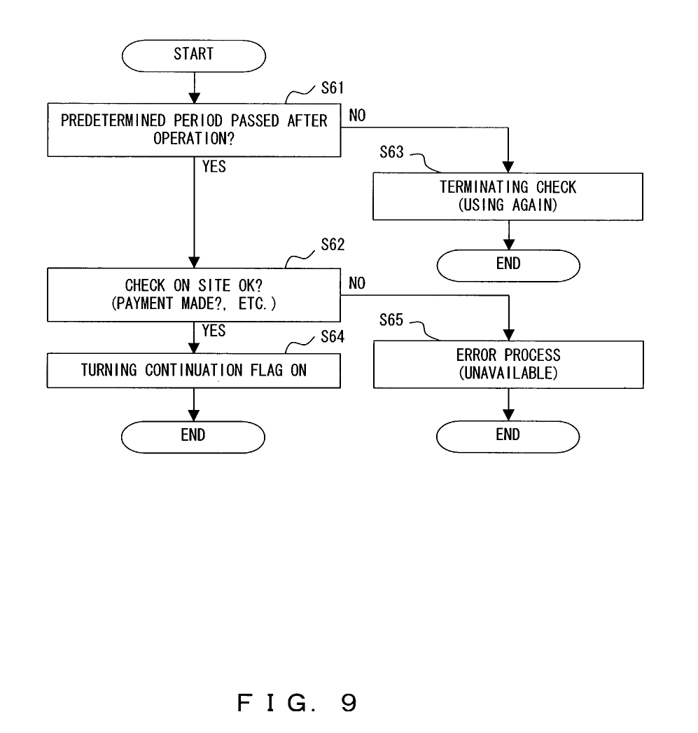

FIG. 9 is a flowchart of the operation (checking (1)) according to the present invention.

In FIG. 9, it is determined in S61 whether or not a predetermined period has passed after the operation. Precisely, it is determined whether or not a predetermined period, for example, two months required to obtain a payment to be made after a purchase of a right of use has been made on credit have passed. If YES, control is passed to S62. If NO, the check is terminated in S63, thereby passing control to reuse.

It is determined in S62 whether or not the check result is YES on the site. In this process, when it is determined YES, a connection is made to the site (server) through a network, it is checked whether or not the payment for the purchased right of use has been duly made (whether or not the payment has been duly made on credit) when a predetermined period has passed, it is checked whether or not a true right of use has expired, has been illegally copied, has been double requested for check, etc. If YES, then the check results are YES, the notification is transmitted to the personal computer of the user in S64, and the continuation flag in the right-of-use DB 11 is set ON. If NO, the check results are NO, the continuation of the use is prohibited with the error process (the use is not permitted) performed, for example, with the continuation flag in the right-of-use DB 11 kept being set OFF.

Thus, For the right of use in the right-of-use DB 11, a connection is made to the site each time a predetermined period has passed so as to check the validity of the right of use. If it is valid, then the continuation flag in the right-of-use DB 11 for the corresponding right of use is set ON, thereby enabling the right to be available. Otherwise, the continuation flag is kept being set OFF, thereby setting the right unavailable. Thus, the right of use is checked every predetermined period to prohibit illegal continuation of use.

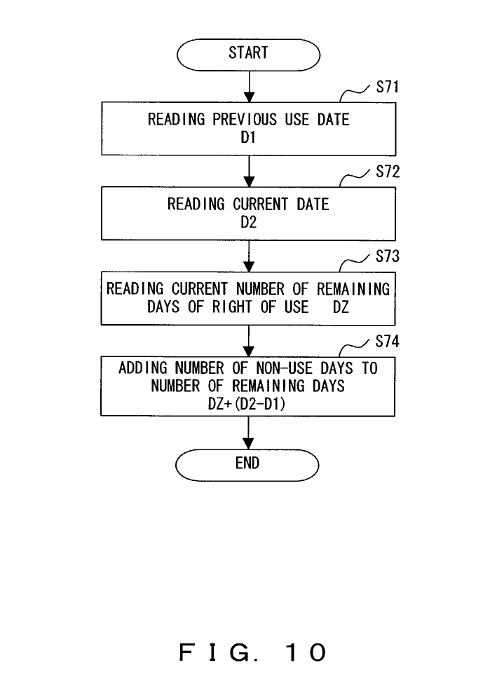

FIG. 10 is a flowchart (check (2)) of the operations according to the present invention.

In FIG. 10, the previous use date (D1) is read in S71. That is, when an operation system is used, the previous use date (D1) of a right of use is read from the right-of-use DB 11.

The current date (D2) is read in S72.

The number of remaining days (DZ) for the right of use is read in S73.

The number of non-use days is added to the number of remaining days in S74. Thus, the number of effective right-of-use days can be computed by the following equation.

DZ+(D2−D1)

As described above, when an operation system is used, the number of effective right-of-use days can be computed with the unused right of use taken into account based on the previous use date (D1), the current date (D2), and the number of remaining days (DZ) for the right of use.

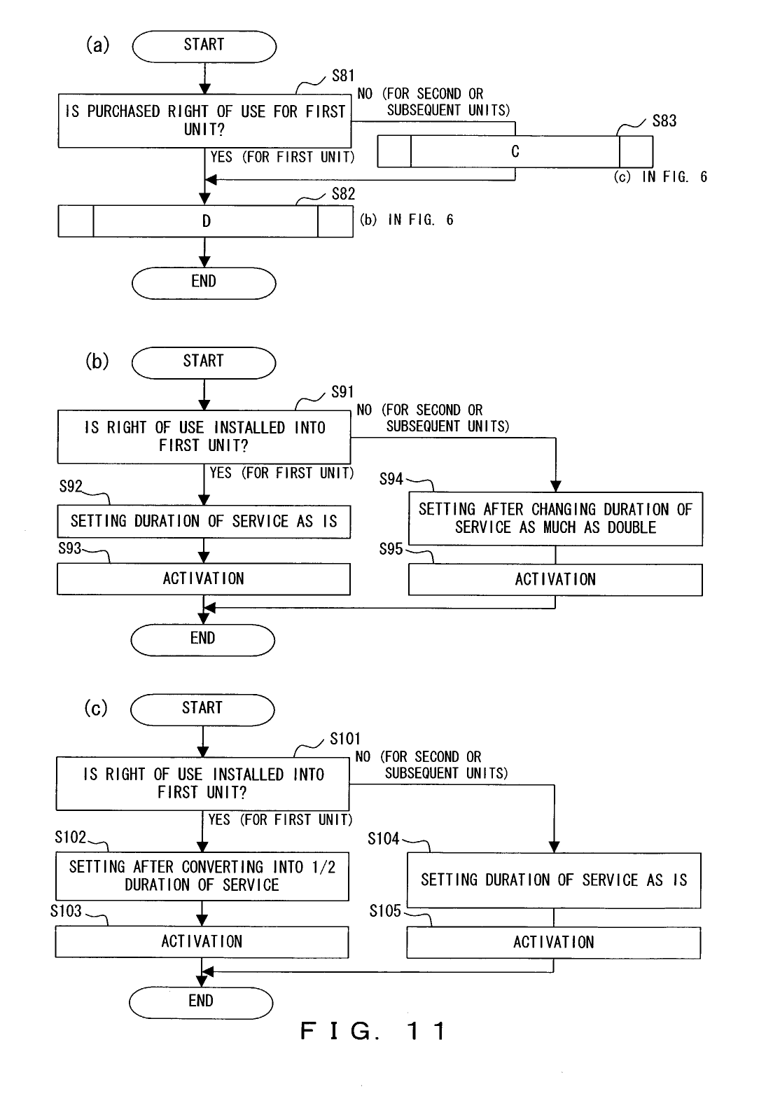

FIG. 11 is a flowchart of the operation (dividing) according to the present invention;

(a) in FIG. 11 shows the entire flowchart of dividing a right of use.

In (a) in FIG. 11, it is determined in S81 whether or not the purchased right of use is for the first unit. In this process, it is determined whether the right of use purchased from the right-of-use file 2 shown in FIG. 3 is for the first unit or for any of the subsequent units. If YES (first unit), it is determined that the purchased right of use is for the first unit, and the process of dividing D (the dividing process of (b) in FIG. 7 as described later) is performed. On the other hand, if the determination is NO, then the purchased right of use is for any of the second and subsequent units, and the process of dividing C (the dividing process of (c) in FIG. 7 as described later) is performed.

(b) in FIG. 11 is a flowchart of dividing the right of use for the first unit.

In (b) in FIG. 11, it is determined in S91 whether or not the right of use is installed in the first unit. If YES,

(1) since the right of use to be installed is for the first unit, and it is determined that the right of use is to be installed in the first personal computer, the full duration of service of the right of use is set in S92, the system is activated in S93, thereby starting using the operation system. On the other hand, if the determination is NO,

(2) since the right of use to be installed is for the first unit, and it is determined that the right of use is to be installed in the second or any of the subsequent personal computers, the duration of service of the right of use is changed into twice as long as the predetermined period (discounted), the system is activated in S95, thereby starting using the operation system.

(c) in FIG. 11 is a flowchart of dividing the right of use for the second and subsequent units.

In (c) shown in FIG. 11, it is determined in S101 whether or not the right of use has been installed for the first unit. If YES,

(3) The right of use to be installed is for the second and subsequent units, and is intended for the first unit of the personal computers. Therefore, the duration of service for the right of use is converted into ½ in S102 (with the duration of service for the first unit being the duration of service for the right of use discounted for the second and subsequent units (in this example, half the period)) and set, the system is activated in S103, and starts using the operation system. If NO,

(4) The right of use to be installed is for the second and subsequent units, and is intended for the second and subsequent unit of the personal computers. Therefore, the duration of service for the right of use is set as is in S104, the system is activated in S105, and starts using the operation system.

Thus, it is determined for the divided rights of use whether the right of use (divided right of use) to be installed is for the first unit or the second and subsequent units, and whether the personal computer to be installed is for the first unit or the second and subsequent units. Then, the duration of service of the right of use is computed in any of the methods (1) through (4) above so as to set it for the right of use registered in the right-of-use DB 11 of the personal computer of the installation destination (export destination, division destination). Thus, the duration of service of the right of use can be recomputed by the personal computer at the export destination including the right of use discounted for the second and subsequent units, and can be automatically set (corrected), thereby enabling the right of use to be managed with a discount applied easily and flexibly.

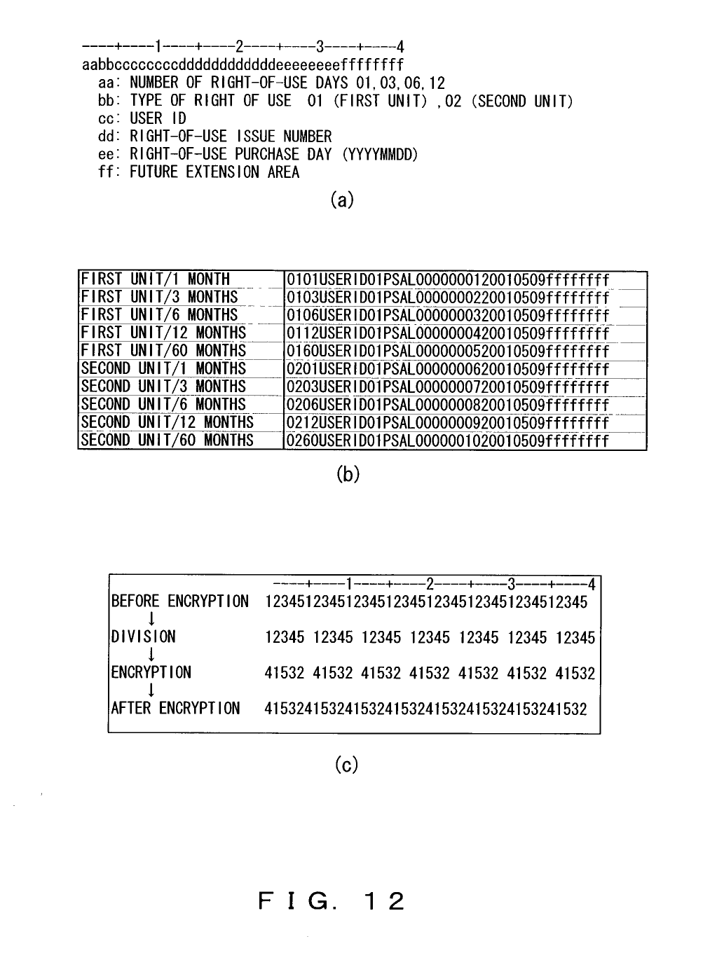

FIG. 12 shows an example of a practical configuration of a right-of-use file.

A right-of-use file is configured, for example, in a text file format as shown by (a) in FIG. 12, and contains from the start of the right-of-use file the number of days for the right-of-use file, the type of right of use, a user ID, a right-of-use issue number, a right-of-use purchase date, and a future extension area (an unused area, but for future use in extending functions) sequentially described based on characters.

As shown by (b) in FIG. 12, the data in the right-of-use file is stored in the format as shown by the character strings on the right in FIG. 12(b). The character strings on the right in FIG. 12(b) can be read in the format of (a) in FIG. 12. Especially, the data of the right-of-use file of (b) in FIG. 12 show the right-of-use issue numbers of PSAL00000001 through PSAL00000010. The right-of-use purchase date is May 9 in 2001.

As shown by (c) in FIG. 12, data is encrypted so that the right-of-use file cannot be illegally obtained and used. The right-of-use file is encrypted first by dividing a text character string into 5-character units, rearranging the sequence of each of the divided character strings into, for example, 4, 1, 5, 3, 2, etc. It is obvious that other encrypting methods can be used.

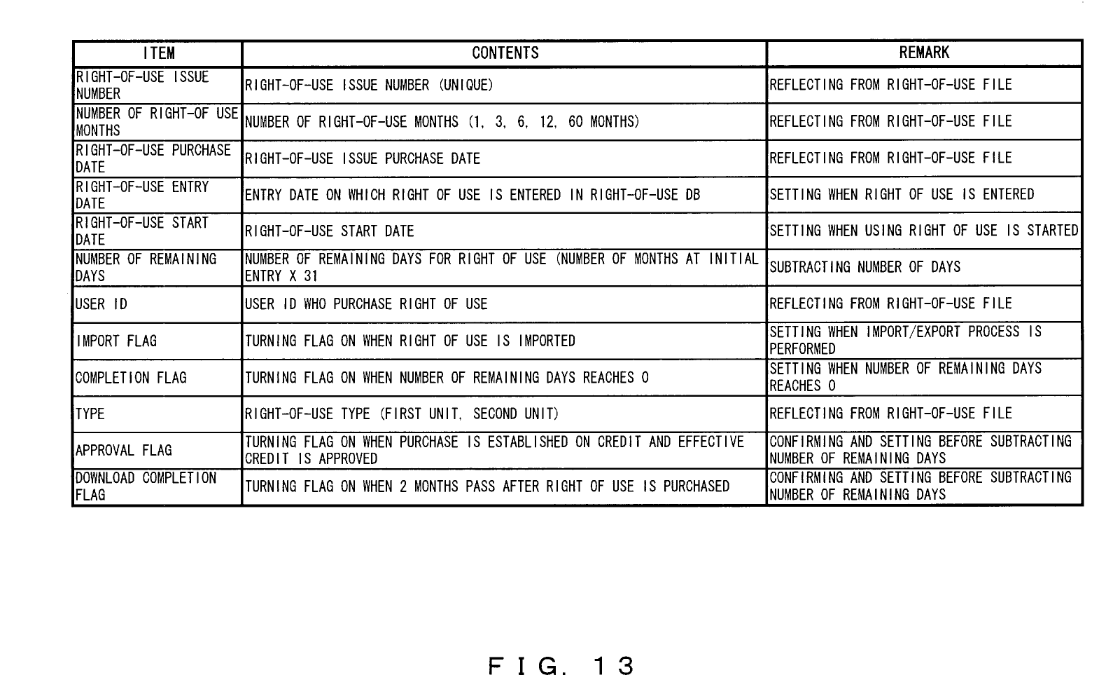

FIG. 13 shows a practical example of the configuration of a right-of-use DB.

A right-of-use DB is provided in the terminal of any server or client who downloads merchandise from a side (a server who sells merchandise on Web, and is described in the following explanation as a terminal purchasing merchandise and providing a service for a client using the merchandise) and installs work software, which is merchandise.

A right-of-use DB comprises a right-of-use issue number, the number of months for a right of use, a right-of-use purchase date, a right-of-use entry date, a right-of-use start date, the number of remaining right-of-use days, a user ID, an import flag, a completion flag, a type, a merchandise flag, and a download completion flag. A right-of-use issue number, the number of months for a right of use, a right-of-use purchase date, a user ID, and a type are copied from the above mentioned right-of-use file and registered. A right-of-use entry date is the date on which a right of use is registered in the right-of-use DB. For example, merchandise is purchased from a site, and installed in a server, and a right of use is purchased and the date on which it is registered in the right-of-use DB of the server is described. For example, a right-of-use start date is described when the merchandise is first used between the server and the client after software (merchandise) is installed in the server and the client. The number of remaining days indicates how many days on which the merchandise is available with the right of use set, remain. The number of remaining days is computed by multiplying the number of months read from the right-of-use file by 31, and is decreased by 1 each time the right of use is used.

An import flag indicates whether or not the right of use set in the right-of-use DB has been imported from other terminals. For example, when a server purchases a right of use from a site, the import flag of the right-of-use DB of the server is turned OFF. However, if a right of use is divided and distributed from the server to each client, then the import flag of the right-of-use DB registered by each client is turned ON.

A completion flag is turned ON when the number of remaining days is 0, and indicates that all rights of use have been completely used. Furthermore, an approval flag indicates whether or not a credit card, etc. is valid when a right of use is used after a right of use is purchased from the site using the credit card, etc. In this process, a terminal which uses the right of use is forced to access the site from which the merchandise is purchased in each predetermined period. Upon receipt of the information about the right of use, the site inquires of the credit company for confirmation of the validity of the credit card of the user registered in the site in association with the right of use. Therefore, when the credit card expires, the user cannot use the right of use although there are a number of remaining days for the right of use, the right of use is unavailable. A download completion flag indicates the time when the user is forced to access the site to set an approval flag. Assuming that two months are set in this example, the download completion flag is turned ON if two months have passed after the download of the merchandise to prompt the user to access the site. If the user accesses the site upon receipt of the instruction, the download completion flag is turned OFF, and is turned ON again after another two months. Thus, by the site periodically having the user confirm whether or not the credit card through which the user purchased the merchandise is valid, the delay of the payment of the user can be avoided.

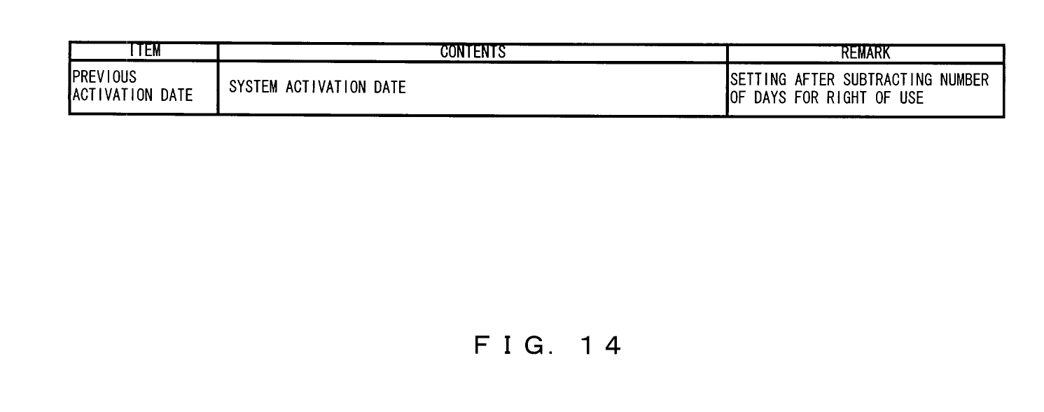

FIG. 14 shows an example of a practical configuration of the activation table previously activated.

On the table shown in FIG. 14, the date and time on which the terminal in which the merchandise has been installed has been activated is registered. In this case, if the user activates the terminal, the terminal refers to the number of remaining days of the right-of-use DB, the number is decreased, and then the activation date is registered as the previous activation date. Thus, when the number of remaining days before the subtraction is 0, the merchandise cannot be used. As a result, although the terminal is activated, the date is not recorded as the previous activation date related to the right of use of the merchandise.

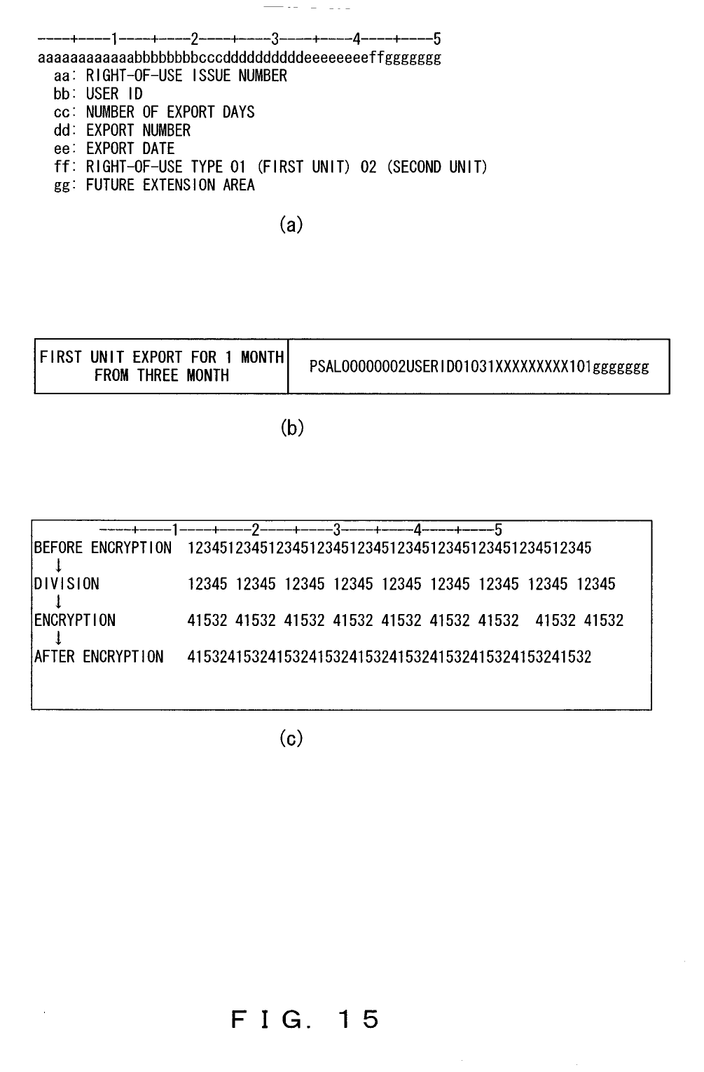

FIG. 15 shows an example of a practical configuration of an import/export file.

The basic configuration of an import/export file is a text file as shown by (a) in FIG. 15. The entries of the import/export file is a right-of-use issue number, a user ID, the number of export days, an export number, an export date, the type of right of use, and a future extension area.

A right-of-use issue number is uniquely assigned to each right of use for use in managing rights of use. A user ID is used in managing users who own rights of use. The number of export days indicates the number of days on which a right of use has been exported. An export number is uniquely assigned in performing the export process to manage the process of exporting operations. An export date is a date on which the export process is performed. The type of right of use indicates the type of exported right of use. A future extension area is an information setting area reserved for future function extension, and is currently unused.

(b) in FIG. 15 shows an example of a configuration of an import/export file. In the example shown by (b) in FIG. 15, a right of use is exported for one month from the first unit (server) to the client (second or subsequent units). The character string on the right of (b) in FIG. 15 can be read in the format shown by (a) in FIG. 15.

As indicated by (c) shown in FIG. 15, data is encrypted so that the import/export file cannot be illegally obtained and used. An example of encryption can be the one such that a text character string in an import/export file is divided into 5-character units as in the case of the right-of-use file and divided character strings are arranged in order as, for example, 4, 1, 5, 3, 2, etc. The encrypting method is not limited to this method.

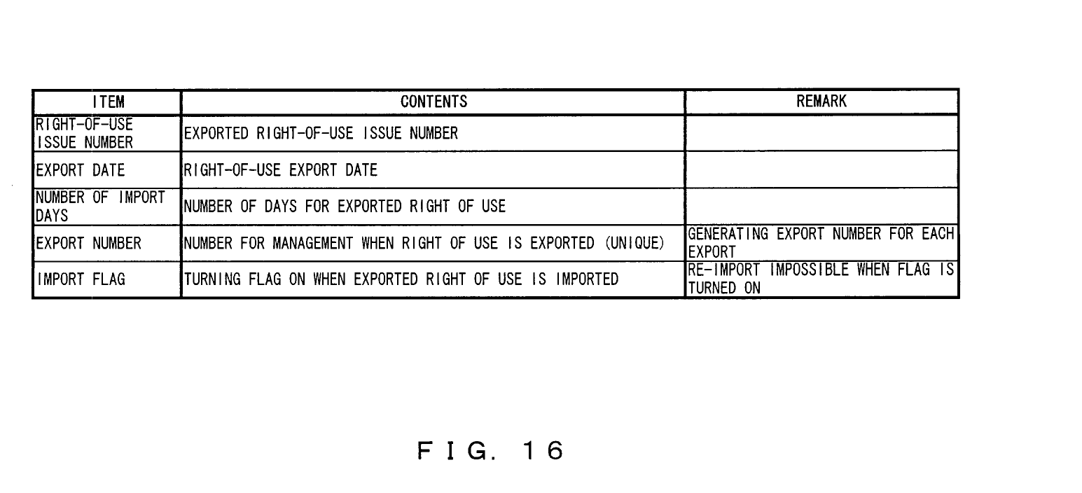

FIG. 16 shows an example of a practical configuration of the import/export management DB.

The import/export management DB is stored in the server (first unit) which purchases merchandise from the site. The entries are a right-of-use issue number, an export date, the number of import days, an export number, an import flag.

A right-of-use issue number is an exported right of use. An export date is a date on which a right of use is exported. The number of export days refers to the number of days on which a right of use is exported. Relating to the number of export days, weights can be different between the server (first unit) and the client (second and subsequent units). For example, assuming that the server is assigned 2 unit and the client is assigned 1 unit, and the number of days on which the right of use is exported from the server is 10, the client can use the right of use for 20 days. In addition, when the rights of use of 10 days are exported from the client to the server, the server can use the right of use only for 5 days. These settings are based on the concept that the amount of use can be changed between the server and the client.

Furthermore, the export number is uniquely assigned to an exporting operation in managing the exporting process when a right of use is exported. An import flag is turned ON when an exported right of use is imported. In this process, the frequency of the operation of importing an exported right of use is limited to once.

The right of use according to the present invention is sold to a client as merchandise to use software merchandise (such as a package, etc.) based on the right of use which is the merchandise purchased by the client, and to receive a service (merchandise which is a service of searching a database) from the site through a network.

According to the present invention, software merchandise is downloaded from the site, and installed into the personal computer of the user, the installed software merchandise is simultaneously or separately used based on the purchased (or imported) right of use, and is used to receive a service from the site. For example,

(1) Support service: A connection is made from a personal computer storing a right of use to a site through a network and a line so as to receive software, etc. A service can also be received using the right of use. The service can be, for example, operations support, research, etc. using a personal computer and the software in the personal computer by transmitting and receiving questions and answers about merchandise through telephone and by operating a keyboard and a mouse connected to the personal computer of a user from the support center.

(2) Information service: A connection is made to a site from the personal computer of a user through a network and a line to receive a result of searching a database (necessary search in the office of the user) and receive various information such as system information, industry information, etc. using the right of use according to the present invention.

(3) Shopping service: A connection is made to a site from the personal computer of the user through a network and a line to receive shopping information about technical books, stationery, law reports, etc. and about technical paper required in the office work, etc. using the right of use according to the present invention.

As described above, one or more rights of use of merchandise are purchased and stored in a right-of-use DB 11 according to the present invention to use merchandise within the range of a right of use, and use merchandise by importing the right of use in another computer system. Therefore, necessary jobs can be performed using a plurality of rights of use, rights of use can be divided for and exported to other computer systems, a discount of a right of use can be allowed when merchandise is imported/purchased, the discount can be removed, etc., thereby realizing a system capable of flexibly managing the rights of use.

What is claimed is:

1. A use right management system managing to use merchandise, comprising:
a right-of-use database storing one or more rights of use of merchandise;
a unit permitting merchandise to be used when it is determined by referring to said right-of-use database that a right of use is obtained, and prohibiting the merchandise from use when it is determined that there is no right of use or the right of use has expired; and
a unit performing a job using the merchandise when using the merchandise is permitted, and decreasing an amount of use from the right of use stored in said right-of-use database.

2. The system according to claim 1, wherein the right of use stored in said right-of-use database is retrieved and exported when a division request is satisfied, and simultaneously deleted from the right-of-use database.

3. The system according to claim 1, further comprising
a unit storing a right of use on said right-of-use database when the right of use is imported or purchased.

4. The system according to claim 1, further comprising
a unit storing in said right-of-use database an undiscounted right of use, a discounted right of use, or a right of use whose discount is restored when the right of use is imported or purchased and an import or purchase target is a first unit or a second or subsequent unit.

5. The system according to claim 1, further comprising
a unit making a check by issuing an inquiry to a purchase source or a predetermined center when a predetermined period passes from a predetermined date such as a date of issue, check, start of operation of the right of use, setting a right of use available when a result of the check indicates validity of the right of use, and setting the right of use kept unavailable or setting the right of use unavailable when a result of the check indicates invalidity of the right of use.

6. The system according to claim 1, further comprising
a unit suppressing subtraction of a non-use period from the right of use when a previous use date and time is compared with a current date and time for the right of use, and it is determined that the non-use period is detected.

7. A computer-readable storage medium storing a program implementing the method comprising:
storing in a right-of-use database one or more rights of use of merchandise;
permitting merchandise to be used when it is determined by referring to said right-of-use database that a right of use is obtained, and prohibiting the merchandise from use when it is determined that there is no right of use or the right of use has expired; and
performing a job using the merchandise when using the merchandise is permitted, and decreasing an amount of use from the right of use stored in said right-of-use database.
